(19) United States
(12) Patent Application Publication
(10) Pub. No.: US 2009/0301576 A1
(43) Pub. Date: Dec. 10, 2009

(54) Water Saving Mechanism For Hot Water Supply Apparatus

(76) Inventors: Shiu-Yen Liu, Taipei City (TW); Chao-Hui Ko, Taipei City (TW)

Correspondence Address: FRENKEL & ASSOCIATES, 3975 UNIVERSITY DR., STE. 330, FAIRFAX, VA, 22030, US

(21) Appl. No.: 12/133,125

(22) Filed: Jun. 4, 2008

(51) Int. Cl. F16K 17/38

(52) U.S. Cl. 137/468

(57) ABSTRACT

The invention is related to a water saving mechanism for hot water supply apparatus. It comprises a water pump unit, a solenoid valve that connects to the water pump unit, a temperature sensor unit that connects to the solenoid valve and a switch unit that connects to the temperature sensor unit. Thus, the water saving mechanism operates with a hot water supply apparatus. When hot water is needed, it uses the water pump unit, the solenoid valve and the switch unit to cut off the cold water and send it back to the hot water supply apparatus for heating. It starts to discharge hot water when the temperature sensor unit senses the water temperature at the preset use temperature. Hence, the invention can prevent waste of discharging cold water and save water resource.

### BACKGROUND OF THE INVENTION

1. Field of the Invention

The invention is related to a water saving mechanism for hot water supply apparatus, especially one that can prevent waste when discharging cold water to save water.

2. Description of the Prior Art

For a traditional hot water supply apparatus (like water heater or hot water tank), there is usually a certain distance between the cold/hot water pipes and the faucet. Hence, after the user turns on the hot water faucet, the user does not get hot water until the cold water in the hot water pipe runs out. This definitely wastes lots of cold water in the hot water pipe. The field test data shows that five to ten liters of water on average are wasted for the above situation.

The cold/hot water pipes for current water heater or hot water tank do not have water saving method. Although some hot water pipes use thermal insulation materials, they still do not instantly supply water at appropriate temperature to the user when the hot water faucet is turned on. They cannot prevent waste of discharging cold water.

### SUMMARY OF THE INVENTION

Therefore, the primary objective for the invention is to prevent waste of discharging cold water to save water resource by adopting a water saving mechanism into a hot water supply apparatus so that when hot water is needed, a water pump unit, a solenoid valve and a switch unit work together to cut off cold water and send it back to the hot water supply apparatus for heating, and start discharging water as a temperature sensor unit senses the water temperature reaches the desired use temperature.

To achieve the above objective, the water saving mechanism for hot water supply apparatus for the invention comprises a water pump unit, a solenoid valve connecting to the water pump unit, a temperature sensor unit connecting to the solenoid valve and a switch unit connecting to the temperature sensor unit.

### BRIEF DESCRIPTION OF THE DRAWINGS

FIG. 1 is the basic configuration for the invention.

FIG. 2 is the status diagram for the invention in use.

FIG. 3 is the localized enlarged diagram for part A in FIG. 2 for the invention.

DESCRIPTION OF MAIN COMPONENTS

| | | | |
|---|---|---|---|
| 1 | water saving mechanism | 13 | temperature sensor unit |
| 11 | water pump unit | 14 | switch unit |
| 12 | solenoid valve | 2 | hot water supply apparatus |
| 121 | inlet | 21 | faucet |
| 122 | first outlet | 31 | hot water pipe |
| 123 | second outlet | 32 | cold water pipe |

### DETAILED DESCRIPTION OF THE PREFERRED EMBODIMENT

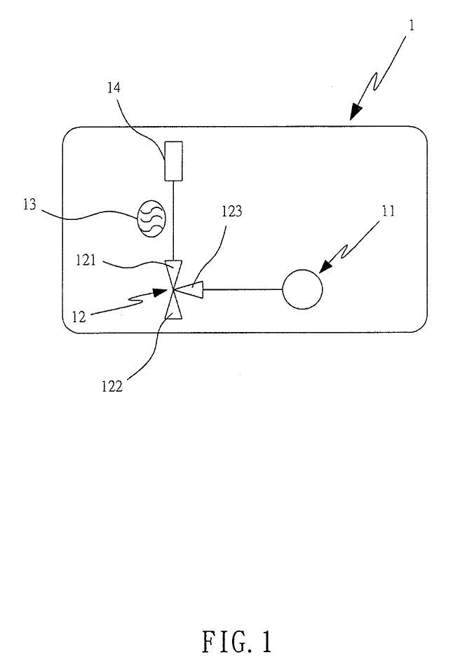

Please refer to FIG. 1 for the water saving mechanism for hot water supply apparatus for the invention. The water saving mechanism (1) comprises a water pump unit (11), a solenoid valve (12), a temperature sensor unit (13) and a switch unit (14). The water pump unit (11), the solenoid valve (12), the temperature sensor unit (13) and the switch unit (14) can be waterproof.

The above-mentioned water pump unit (11) can be an electrical water pump.

The solenoid valve (12) connects to the water pump unit (11). The solenoid valve (12) can have a three-way solenoid valve that connects to an inlet (121), a first outlet (122) and a second outlet (123). When the solenoid valve (12) is not electrically connected, the water enters at the inlet (121) and leaves from the first outlet (122); while when the solenoid valve (12) is electrically connected, the water leaves from the second outlet (123).

The temperature sensor unit (13) connects to the solenoid valve (12). The temperature sensor unit (13) can be an adjustable temperature-sensing close-circuit switch. When the environment temperature is sensed to be above the set temperature by the temperature sensor unit (13), the close-circuit switch opens and cuts off the circuit; while the sensed temperature is below the set temperature, the circuit is back to close state.

The switch unit (14) connects to the temperature sensor unit. The switch unit is a water flow switch with two contact points. When the water flows, the two contact points are pressed to close for electrical circuit connection. When the water stops, the two contact points open to cut off the circuit. Thus, the above mechanism constitutes a novel water saving mechanism for hot water supply apparatus.

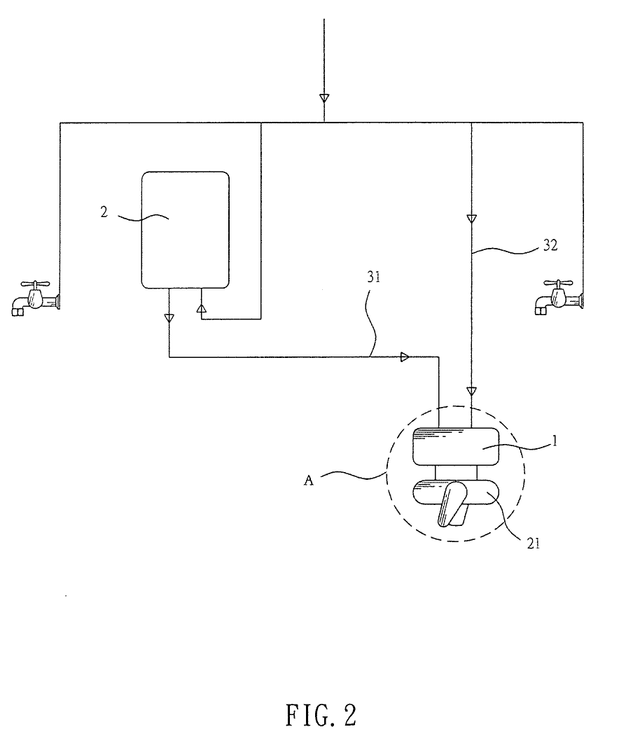

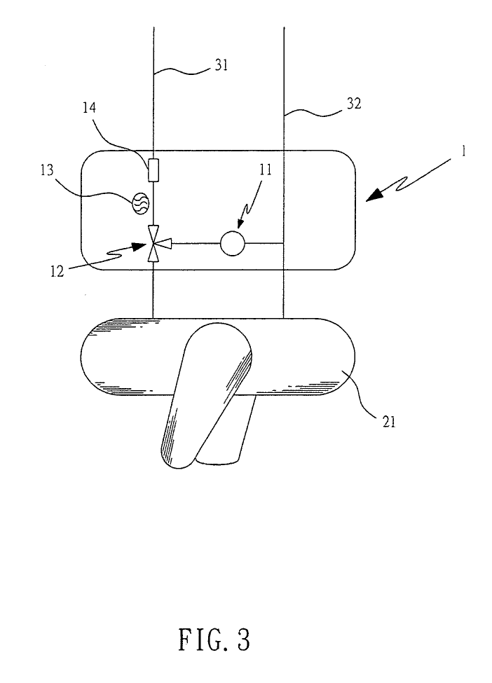

Please refer to FIG. 2 and FIG. 3. As shown in the figures, the invention can be used for the cold/hot water pipes in a common hot water supply apparatus (2) (like water heater or hot water tank) that uses water pressure difference to start or ignite the heater. For assembly, the water saving mechanism (1) is installed in a proper place of the cold/hot water pipes or before the cold water and the hot water mix and meet at the faucet (21). Besides, in the hot water pipe (31) of the cold/hot water pipes, a temperature sensor unit (13), a switch unit (14) and a solenoid valve (12) are installed, so the solenoid valve (12) connects to the water pump unit (11), and then to the cold water pipe (32). This completes the apparatus for the invention.

When hot water is needed and the faucet (21) is turned to hot water position, water flow occurs in the hot water pipe (31) to activate the switch unit (14) and electrical circuit connection. This allows the water pump unit (11) and the solenoid valve (12) to activate and cut off the path from the hot water pipe (31) to the faucet (21) and reverts the water flow from the water pump unit (11) to the cold water pipe (32). At this moment since the cold water outlet for the faucet (21) is not open, the cold water returns to the hot water supply apparatus (2) and forms a circulation loop with the water pump unit (11). Thus, a water pressure difference is created to ignite the hot water supply apparatus (2) to heat the water or the water flow drives the hot water inside the hot water supply apparatus (2) into the hot water pipe (31). When the water reaches the set temperature before it flows to the faucet (21), the temperature sensor unit (13) will sense it and simultaneously cuts off the control circuit. At this moment, the water pump unit (11) and the solenoid valve (12) also stop to allow the hot water pipe (31) to return to the initial state. As a result, the water at preset temperature runs out from the faucet (21) outlet. Overall, this can prevent waste of discharging water and save water resource.

In summary, for the water saving mechanism for hot water supply apparatus for the invention, it can operate with the hot water supply apparatus. So when hot water is needed, it uses a water pump unit, a solenoid valve and a switch unit to cut off the cold water and send it back to the hot water supply apparatus for heating. When the temperature sensor unit senses the water temperature reaches the preset use temperature, it starts to supply water. By preventing waste of discharging cold water and saving water resource, the invention proves to be progressive and pragmatic and meet user's needs. The invention in fact has met the requirements for patent application, which is accordingly submitted.

The above description is merely for the preferred embodiments for the invention, but not to limit the scope of the invention. Therefore, those with equivalent change or modification based on the description for the invention shall still be covered within the claims of the invention.

What is claimed is:

1. A water saving mechanism for hot water supply apparatus comprises:
a water pump unit;
a solenoid valve that connects to the above water pump unit;
a temperature sensor unit that connects to the above solenoid valve; and
a switch unit that connects to the above temperature sensor unit.

2. According to claim 1 for the water saving mechanism for hot water supply apparatus, the solenoid valve is a three-way solenoid valve that connects to an inlet, a first outlet and a second outlet.

3. According to claim 1 for the water saving mechanism for hot water supply apparatus, the switch unit is a water flow switch with two contact points.
